(19) United States
(12) Patent Application Publication
(10) Pub. No.: US 2026/0051272 A1
(43) Pub. Date: Feb. 19, 2026

(54) MODE SWITCHING METHOD, ELECTRONIC DEVICE AND TRANSITORY COMPUTER-READABLE STORAGE MEDIUM

(71) Applicant: Beijing Zitiao Network Technology Co., Ltd., Beijing (CN)

(72) Inventors: Qinghua YANG, Beijing (CN); Junyuan LIU, Beijing (CN); Guanyi REN, Beijing (CN); Yuechuan ZHANG, Beijing (CN); Nongwei LEI, Beijing (CN); Mingfei SONG, Beijing (CN); Wei XIE, Beijing (CN); Xiaolong WANG, Beijing (CN); Xiaofei FANG, Beijing (CN)

(21) Appl. No.: 19/304,321

(22) Filed: Aug. 19, 2025

(30) Foreign Application Priority Data
Aug. 19, 2024 (CN) 202411139712.1

(51) Int. Cl. G09G 3/00; G06F 3/04847

(52) U.S. Cl. CPC G09G 3/001; G06F 3/04847; G09G 2340/0435; G09G 2354/00

(57) ABSTRACT

The present disclosure relates to a mode switching method, an electronic device, and a non-transitory computer-readable storage medium. The mode switching method includes: displaying a mode selection page in an extended reality space in response to a trigger operation for a mode switching entry, during a process that the extended reality device is running in a first running mode, the mode selection page including a second mode switching option; and switching a running mode of the extended reality device to the second running mode in response to a selection operation for the second mode switching option; an amount of resources occupied by a base running of a system of the extended reality device is greater in the first running mode than that in the second running mode.

### CROSS-REFERENCE TO RELATED APPLICATION

This application claims the priority to and benefits of the Chinese Patent Application No. 202411139712.1, which was filed on Aug. 19, 2024. The aforementioned patent application is hereby incorporated by reference in its entirety.

### TECHNICAL FIELD

The present disclosure relates to a mode switching method, an electronic device, and a non-transitory computer-readable storage medium.

### BACKGROUND

Extended Reality (Extended Reality, XR) refers to the combination of the real and the virtual through a computer to create a virtual environment capable of human-computer interaction. XR is also a general term for various technologies such as virtual reality (Virtual Reality, VR), augmented reality (Augmented Reality, AR) and mixed reality (Mixed Reality, MR) and so on. By integrating the visual interaction technologies of these three, it brings the “immersive feeling” of seamless transition between the virtual world and the real world to the experiencer. However, in the extended reality device, due to the limitation of available system resources, the system often does not support users to start multiple applications simultaneously.

### SUMMARY

In order to solve the above-described technical problems or at least partially solve the above-described technical problems, the present disclosure provides a mode switching method, an electronic device, and a non-transitory computer-readable storage medium.

The present disclosure provides a mode switching method, including:
displaying a mode selection page in an extended reality space in response to a trigger operation for a mode switching entry, during a process that the extended reality device is running in a first running mode, the mode selection page including a second mode switching option; and
switching a running mode of the extended reality device to the second running mode in response to a selection operation for the second mode switching option; where, in the first running mode, an amount of resources occupied by a base running of a system of the extended reality device is a first amount of resources; in the second running mode, the amount of resources occupied by the base running of the system of the extended reality device is a second amount of resources, the first amount of resources is greater than the second amount of resources; when the running mode of the extended reality device is switched from the first running mode to the second running mode while running a same application, running performance of the application in the extended reality device remains unchanged.

The present disclosure further provides a mode switching apparatus, including:
a display module, configured for displaying a mode selection page in an extended reality space in response to a trigger operation for a mode switching entry, during a process that the extended reality device is running in a first running mode, the mode selection page including a second mode switching option; a switching module configured for switching a running mode of the extended reality device to the second running mode in response to a selection operation for the second mode switching option; where, in the first running mode, an amount of resources occupied by a base running of a system of the extended reality device is a first amount of resources; in the second running mode, the amount of resources occupied by the base running of the system of the extended reality device is a second amount of resources, the first amount of resources is greater than the second amount of resources; when the running mode of the extended reality device is switched from the first running mode to the second running mode while running a same application, running performance of the application in the extended reality device remains unchanged.

The present disclosure further provides an electronic device, the electronic device including: one or more processor; and
a memory for storing one or more programs;
when the one or more programs are executed by the one or more processor, the one or more processor implements the mode switching method as described above.

The present disclosure further provides a non-transitory computer-readable storage medium having computer program stored thereon. When the program is executed by the processor, the mode switching method as described above is implemented.

### BRIEF DESCRIPTION OF DRAWINGS

The accompanying drawings, which are incorporated in and constitute a part of this specification, illustrate embodiments consistent with the disclosure and together with the description, serve to explain the principles of the disclosure.

In order to more clearly explain the embodiments of the present disclosure or the technical solutions in the prior art, the drawings needed to be used in the description of the embodiments or the prior art will be briefly introduced below. Obviously, for those of ordinary skill in the art, other drawings may also be obtained based on these drawings without exerting creative effort.

FIG. 1 is a flowchart of a mode switching method according to an embodiment of the present disclosure;

FIGS. 2-4 are schematic diagrams of a user's field-of-view image when an extended reality device is used according to an embodiment of the present disclosure;

FIG. 5 is a schematic structural diagram of a mode switching apparatus according to an embodiment of the present disclosure; and

FIG. 6 is a schematic structural diagram of an electronic device according to an embodiment of the present disclosure.

### DETAILED DESCRIPTION

In order that the above objects, features and advantages of the present disclosure may be more clearly understood, aspects of the present disclosure will be further described below. It should be noted that the embodiments of the present disclosure and the features in the embodiments may be combined with each other without conflict.

In the following description, numerous specific details are set forth in order to provide a thorough understanding of the disclosure, but the disclosure may be practiced otherwise than as described herein. Obviously, the embodiments in the specification are only some, not all, of the embodiments of the present disclosure.

Embodiments of the present disclosure provide a mode switching method, the method may be executed by a mode switching apparatus, the apparatus may be implemented by software and/or hardware, and the apparatus may be configured in an extended reality device.

The extended reality device described in the present application may include, but are not limited to, computer-side extended reality devices, mobile extended reality devices and all-in-one extended reality devices.

The computer-side extended reality devices use the PC to perform related calculations and data output of extended reality functions, and the external computer-side extended reality device uses the data output from the PC to achieve the effect of extended reality.

The mobile extended reality devices support the installation of mobile terminal (such as smartphones) in various ways (such as head-mounted display equipped with a dedicated card slot). Through wired or wireless connections with the mobile terminal, the mobile terminals perform related calculations for extended reality functions and output data to the mobile extended reality device. For example, extended reality videos may be viewed through APP on the mobile terminals.

All-in-one extended reality devices are equipped with processors for performing relevant calculations of virtual functions. As a result, they have the functions of independent extended reality input and output. They do not need to be connected to a PC or a mobile terminal, providing a high degree of freedom in use.

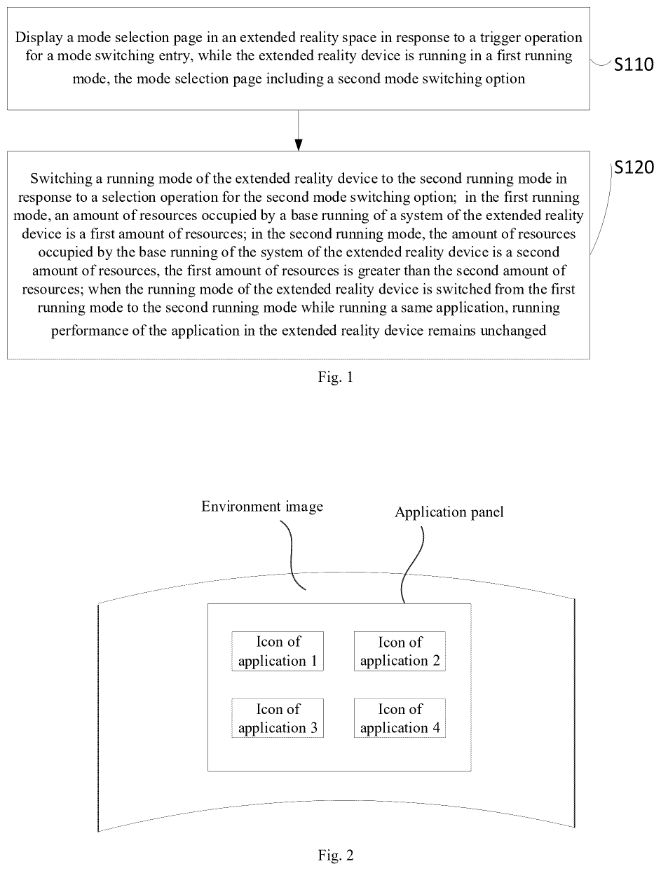

FIG. 1 is a flowchart of a mode switching method according to an embodiment of the present disclosure. Referring to FIG. 1, the method may specifically include steps S110 and S120.

At step S110, display a mode selection page in an extended reality space in response to a trigger operation for a mode switching entry, while the extended reality device is running in a first running mode, where the mode selection page includes a second mode switching option.

There are a system and applications in the extended reality device. The system may refer to, for example, an operating system of the extended reality device, which is responsible for functions such as managing hardware resources, providing a user interface, and supporting the running of applications. Applications may be, for example, software running on the extended reality device that provides specific functions or services, such as games, educational software, social applications, etc.

In the extended reality device, there is a close relationship between the system and the applications. The system provides an operating environment and support for the applications, while the applications use the resources and services provided by the system to achieve specific functions and services. Specifically, during the running of the extended reality device, the system is responsible for allocating resources according to the requirements of the application, such as CPU resources, GPU resources, internal memory space, etc. The system also controls the access rights of the applications to the device functions and resources through a permission management mechanism to ensure the security and stability of the applications. The system also provides a user interface framework for the applications to help them interact effectively with users.

It should be noted that in practice, not only the running of the applications will occupy system resources (such as CPU resources, GPU resources, and internal memory space), but the running of the system itself also needs to occupy system resources.

In the present application, the extended reality device may be run in the first running mode or the second running mode.

The original design intention of the first running mode is to ensure that the performance of the system and the applications is in a better state. In the first running mode, both the running of the system and the running of the applications may occupy more system resources. When the total system resources of the extended reality device are constant and the extended reality device is running in the first running mode, the number of the applications that may be run is small. In other words, in the first running mode, it is impossible to support the simultaneous running of multiple applications, and it is impossible to display windows of multiple applications at the same time.

The original design intention of the second running mode is to ensure the performance of the applications by sacrificing part of the system performance. In other words, when the extended reality device is running in the second running mode, the performance of the applications is better, but the performance of the system is poor. Compared with the first running mode, in the second running mode, the resources occupied by running of the system will be reduced. When the total system resources of the extended reality device are constant, more system resources may be reserved to support the running of the applications. This enables a greater number of applications running to be supported in the second running mode as compared to the first running mode. In other words, in the second running mode, windows of a plurality of applications may be displayed simultaneously.

The mode switching entry may be, for example, an option, a control, a link, a physical button provided on the extended reality device that brings the user to a mode selection page, or the like. The trigger operation for the mode switching entry may be, for example, an instruction indicating that it is desired to reach the mode selection page through the mode switching entry. Exemplarily, the trigger operation for the mode switching entry may include a tap or swipe operation of the user on the mode switching entry, swipe operation, or a touch or press operation on a physical button provided on the extended reality device corresponding to the mode switching entry, and so on.

Extended reality space refers to an immersive digital environment created through extended reality devices. A user may enter and interact with this environment by wearing corresponding devices (such as head-mounted displays, handles, etc.).

It should be noted here that, referring to FIG. 2, when the user starts the extended reality device, the virtual space entered is the extended reality space. An application panel may be displayed in the extended reality space, and the application panel may include icons of a plurality of applications. These applications may be 2D application or 3D application. The user may select one of the icons of the applications in the application panel and trigger it. After triggering, the triggered application will be started. When the 3D application is started, the user will enter the space rendered by the 3D application, and the space rendered by the 3D application does not belong to the extended reality space mentioned in this application. When the 2D application is started, the window of the 2D application may be displayed in extended reality space. In other words, the function of extended reality space is similar to that of computer desktop.

The extended reality space is created by the environmental image, and the environment image is similar to desktop wallpaper.

The mode selection page may be, for example, a page that assists the user in performing mode selection. In some embodiments, the mode selection page may be set to include a second mode switching option. In other embodiments, the mode selection page may further include a first mode switching option. The first mode switching option corresponds to the first running mode, and the second mode switching option corresponds to the second running mode. When the user performs a selection operation for the first mode switching option, the extended reality device will be caused to run in the first running mode. When the user performs a selection operation for the second mode switching option, the extended reality device will be caused to run in the second running mode.

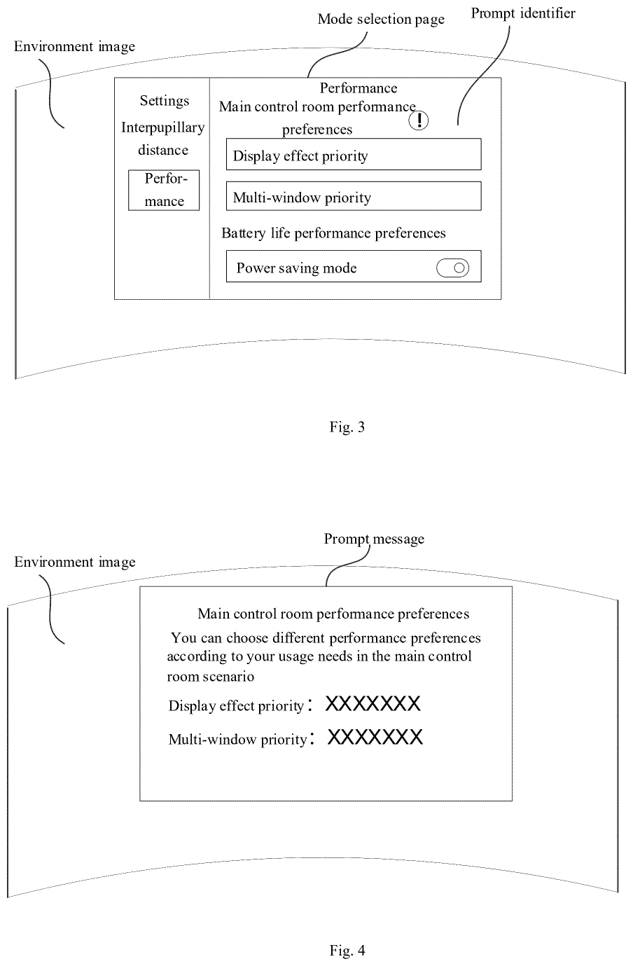

By way of example, referring to FIG. 3, a plurality of options, such as “Interpupillary distance” and “Performance”, are set in a setting page of the extended reality device. Among them, “Performance” refers to the mode switching entry. When the user taps “Performance”, a mode selection page is displayed. There are options such as “Display effect priority” and the “Multi-window priority” in the mode selection page. The option of “Display effect priority” is the first mode switching option. The option of “Multi-window priority” is the second mode switching option.

At step S120, switch a running mode of the extended reality device to the second running mode in response to a selection operation for the second mode switching option. In the first running mode, an amount of resources occupied by a base running of a system of the extended reality device is a first amount of resources, and in the second running mode, the amount of resources occupied by the base running of the system of the extended reality device is a second amount of resources. The first amount of resources is greater than the second amount of resources. When the running mode of the extended reality device is switched from the first running mode to the second running mode while running a same application, running performance of the application in the extended reality device remains unchanged.

The amount of resources occupied by the base running of the system of the extended reality device refers to the amount of resources (such as CPU resources, GPU resources, and internal memory space) occupied by the running of the system itself when no application are running.

As before, it is precisely because the original design intention of the second running mode is to sacrifice part of the system performance to ensure the performance of the applications. “Sacrificing part of the system performance” is reflected in the fact that the first amount of resources in the first running mode is greater than the second amount of resources in the second running mode. “To ensure the performance of the applications” is reflected in the fact that when the running mode of the extended reality device is switched from the first running mode to the second running mode when running the same application, the running performance of application in the extended reality device remains unchanged.

In the above-described technical solution, the running mode of the extended reality device is switched to the second running mode by setting the selection operation in response to the second mode switching option. In the first running mode, an amount of resources occupied by a base running of a system of the extended reality device is a first amount of resources; in the second running mode, the amount of resources occupied by the base running of the system of the extended reality device is a second amount of resources, the first amount of resources is greater than the second amount of resources. When the running mode of the extended reality device is switched from the first running mode to the second running mode while running a same application, running performance of the application in the extended reality device remains unchanged. Its essence is to provide a new running mode (that is, the second running mode). In this running mode, due to the deterioration of system performance compared with that in the first running mode, more system resources may be freed up to support the running of applications, which may improve the running effect of the applications.

On the basis of the above technical solution, optionally, in response to a selection operation for the second mode switching option, adjusting configuration parameters related to display performance of an environment image in the extended reality space, such that the display performance of the environment image in the extended reality space is higher in the first running mode than in the second running mode.

Optionally, the configuration items of the first type include at least one selected from a group consisting of a size of an eye buffer and a refresh rate of the environment image displayed in the extended reality space.

The eye buffer may be, for example, a size of a buffer area configured for rendering of the left and right eye images during image processing. The left and right eyes images here specifically refer to the environment image.

The refresh rate of the environment image displayed in the extended reality space may be, for example, the number of times of updates per unit time of the environment image displayed in the extended reality device.

By setting and adjusting the configuration parameters related to the display performance of the environment image in the extended reality space, the display performance of the environment image in the extended reality space is higher in the first running mode than in the second running mode. Its essence is that compared with that in the first running mode, in the second running mode, it may achieve the purpose of reducing the amount of resources occupied by the base running of the system by reducing the display performance of the environment image in the system, so as to free up more system resources and better support the running of the applications. Because the user's attention is mainly focused on the window of application after starting the application, the perception of environment image will be weakened. Therefore, reducing the display performance of the environment image has little impact on the user experience.

In practice, the environment image may be a virtual image or a real image. A virtual image is completely generated by an extended reality device, and it does not exist in the real world, but is used to build a purely virtual environment. The real image is an image of the physical world captured by an environment camera.

In some scenes, an extended reality device has a perspective function. When the perspective function is in an on state, the environment image is the real image, which means that a user may see physical space where they are through the extended reality device, while virtual content (such as icons of applications, windows of applications, etc.) are superimposed on this real background. When the perspective function is in an off state, the environment image is a virtual image, which means that the environment image seen by a user has nothing to do with their physical environment where they are, but is a virtual scene completely created by software.

Further, when the extended reality device has a perspective function; when the extended reality device is running in the first running mode and the perspective function is activated, configuration items related to the performance of the environment camera in the extended reality device are configured using the first perspective parameter; when the extended reality device is running in the second running mode and the perspective function is activated, the configuration items related to the performance of the environment camera in the extended reality device are configured using the second perspective parameter. The performance of the environment camera is higher in the first running mode than in the second running mode.

When the perspective function is activated, the environment camera periodically captures image of the real physical space environment where the user is located, and presents the captured image within the user's field of view.

Optionally, the configuration items related to the performance of the environment camera in the extended reality device include at least one of the following: a perspective refresh rate and a perspective definition. The perspective refresh rate may be, for example, the frequency of image capture by the environment camera within a unit time (e.g. one second). The perspective definition may be, for example, the resolution of the image captured by the environment camera.

The first perspective parameter and the second perspective parameter are different perspective parameters. By using different perspective parameters, the performance of the environment camera is higher in the first running mode than in the second running mode, and the purpose is to further reduce the performance of the environment camera in the second running mode compared to that in the first running mode when the perspective function is activated, so as to free up more system resources in order to better support the operation of the applications. The performance of environment camera will affect the display effect of environment image. Similarly, because the user's attention is mainly focused on the window of application after starting the application, the perception of environment image will be weakened. Therefore, reducing the performance of environment camera has little impact on the user experience.

On the basis of the above-described technical solutions, optionally, when the extended reality device runs in the second running mode, the method further includes: when a window of a first application is already displayed in the extended reality space, responding to a selection operation for a second application; and displaying both of the window of the first application and a window of a second application in the extended reality space. The essence of this setting is that in the second running mode, multiple application windows are supported to be displayed simultaneously. This setting is convenient for a user to view and operate different applications at the same time, so as to reduce the time of switching application windows.

On the basis of the above technical solution, optionally, the mode selection page further includes a third mode switching option. The method further includes: switching the running mode of the extended reality device to the third running mode in response to a selection operation for the third mode switching option; in the second running mode, an amount of resources occupied by the base running of a system of the extended reality device is a second amount of resources; in the third running mode, an amount of resources occupied by the base running of the system of the extended reality device is a third amount of resources; the second amount of resources is greater than the third amount of resources; when the running mode of the extended reality device is switched from the second running mode to the third running mode while running a same application, running performance of the application in the extended reality device is reduced.

The third mode switching option may be, for example, a control, a link, or the like for switching the operation mode of the extended reality device to the third operation mode.

The third operating mode (in some scenarios, it may be called power-saving mode) is originally designed to sacrifice part of system performance and part of application performance to extend the battery life duration of the extended reality device. In other words, when the extended reality device is running in the third running mode, both the system performance and the application performance are poor compared to those in the first running mode. It should be emphasized that a prominent difference between the second running mode and the third operating mode is whether the performance of the application is deteriorated.

Because the first resource amount in the first running mode is greater than the second resource amount in the second running mode, and the second resource amount in the second running mode is greater than or equal to the third resource amount in the third operation mode, it means that the first resource amount in the first running mode is greater than the third resource amount in the third operation mode. This is because of “sacrificing part of performance of the system” in the original design intention of the third running mode.

“Sacrificing part of performance of the application” is reflected in the fact that when the operation mode of the extended reality device is switched from the second running mode to the third operation mode while running the same application, the running performance of the application in the extended reality device is reduced.

In practice, it may be provided that the operating mode of the extended reality device is allowed to be switched to the third operating mode either while the extended reality device is running in the first running mode or in the second running mode.

When the mode selection page is set to also include a third mode switching option, it may meet the user's requirements for long battery life.

Further, when the extended reality device is in the third running mode, the second mode switching option in the mode selection page may be set to be placed in the restricted selection state.

The second mode switching option is in the restricted selection state, meaning that it is not allowed to switch the extended reality device to the second running mode.

Optionally, when the third running mode is in the use state, the running mode of the extended reality device is restricted from being switched to the first running mode or the second running mode. When the third running mode is in an unused state, the extended reality device is allowed to switch between the first running mode and the second running mode. The purpose of this setting is to make the third running mode at the highest level, so as to ensure that the purpose of extending the battery life may be finally realized.

On the basis of the above technical solution, optionally, the mode selection page further includes a prompt identifier. The method further includes, in response to a trigger operation for the prompt identifier, displaying prompt information. The prompt information is configured to prompt a difference between the first running mode and the second running mode.

The prompt identifier may, for example, refer to a token or an icon used to revoke prompt information. In particular, it may be any form of identifier, and the present application is not limited thereto.

Trigger operation for the prompt identifier may be, for example, tap operation or swipe operation for the prompt identifier.

For example, referring to FIG. 3, the prompt identifier is in the shape of an exclamation mark. When the user taps on the prompt identifier, prompt information is displayed in the form of pop-up window. Referring to FIG. 4, the prompt information is used to prompt the difference between the first running mode and the second running mode to assist the user in selecting a mode that meets his or her own requirements.

It should be noted that the above-described method embodiments are described as a series of combinations of operations for simplicity of description, but those skilled in the art should recognize that the present disclosure is not limited by the described sequence of operations, because according to the present disclosure, some steps may be performed in other sequences or simultaneously. Secondly, those skilled in the art should also understand that the embodiments described in the specification are preferred embodiments, and the acts and modules involved are not necessarily necessary for the present disclosure.

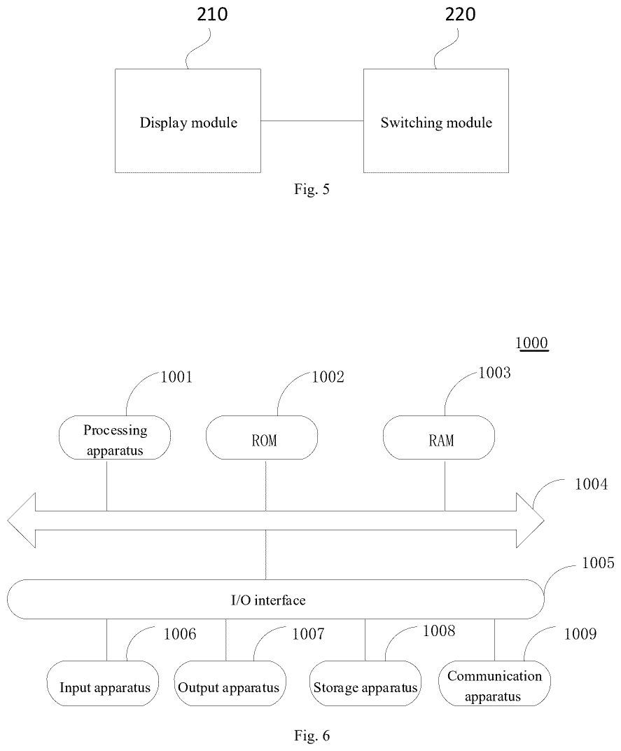

FIG. 5 is a schematic structural diagram of a mode switching apparatus according to an embodiment of the present disclosure. The mode switching apparatus according to the embodiment of the present disclosure may be configured in an extended reality device. Referring to FIG. 5, the model switching apparatus specifically includes a display module 210 and a switching module 220.

The display module 210 is configured to display a mode selection page in an extended reality space in response to a trigger operation for a mode switching entry, while the extended reality device is running in a first running mode. The mode selection page includes a second mode switching option.

The switching module 220 is configured to switch a running mode of the extended reality device to the second running mode in response to a selection operation for the second mode switching option. In the first running mode, an amount of resources occupied by a base running of a system of the extended reality device is a first amount of resources. In the second running mode, the amount of resources occupied by the base running of the system of the extended reality device is a second amount of resources. The first amount of resources is greater than the second amount of resources. When the running mode of the extended reality device is switched from the first running mode to the second running mode while running a same application, running performance of the application in the extended reality device remains unchanged.

Further, the switching module 220 is configured to: in response to a selection operation for the second mode switching option, adjust configuration parameters related to display performance of an environment image in the extended reality space, such that the display performance of the environment image in the extended reality space is higher in the first running mode than in the second running mode.

Further, when the extended reality device has a perspective function, the apparatus includes a perspective module. The perspective module is configured to:
in response to that the extended reality device is running in the first running mode and the perspective function is enabled, configuration items related to performance of an environment camera in the extended reality device are configured by using first perspective parameters;
in response to that the extended reality device is running in the second running mode and the perspective function is activated, the configuration items related to the performance of the environment camera in the extended reality device are configured by using second perspective parameters; and the performance of the environment camera is higher in the first running mode than in the second running mode.

Further, the configuration parameters related to the display performance of the environment image in the extended reality space includes at least one selected from a group consisting of an eye buffer and a refresh rate of the environment image displayed in the extended reality space.

The configuration items related to the performance of the environment camera in the extended reality device include at least one selected from a group consisting of a perspective refresh rate and a perspective definition.

Further, when the extended reality device is operated in the second running mode, the apparatus further includes an application running module. The application running module is configured to: when a window of a first application is already displayed in the extended reality space, responding to a selection operation for a second application; and displaying both of the window of the first application and a window of a second application in the extended reality space.

Further, the mode selection page further includes a third mode switching option switching module. A switching module is configured to:

switching the running mode of the extended reality device to the third running mode in response to a selection operation for the third mode switching option; in third first running mode, an amount of resources occupied by the base running of a system of the extended reality device is a third amount of resources; the second amount of resources is greater than the third amount of resources. When the running mode of the extended reality device is switched from the second running mode to the third running mode while running a same application, running performance of the application in the extended reality device is reduced.

Further, the switching module is further configured to: when the extended reality device is in the third running mode, place the second mode switching option in the mode selection page into a restricted selection state.

Further, the mode selection page further includes a prompt identifier. The apparatus further includes a prompt information display module. The prompt information display module is configured to:
in response to a trigger operation for the prompt identifier, display prompt information, the prompt information is configured to prompt a difference between the first running mode and the second running mode.

The mode switching apparatus provided by the embodiment of the present disclosure may execute the steps in the mode switching method provided by the embodiment of the method of the present disclosure, and has the execution steps and beneficial effects, and will not be repeatedly described herein.

FIG. 6 is a structural schematic diagram of an electronic device in an embodiment of the present disclosure. Referring to FIG. 6, FIG. 6 illustrates a schematic structural diagram of an electronic device 1000 suitable for implementing some embodiments of the present disclosure. The electronic devices 1000 in embodiments of the present disclosure may include, but are not limited to, mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, smart home devices or the like. The electronic device illustrated in FIG. 6 is merely an example, and should not pose any limitation to the functions and the range of use of the embodiments of the present disclosure.

As illustrated in FIG. 6, the electronic device 1000 may include a processing apparatus 1001 (e.g., a central processing unit, a graphics processing unit, etc.), which can perform various suitable actions and processing according to a program stored in a read-only memory (ROM) 1002 or a program loaded from a memory 1008 into a random-access memory (RAM) 1003, so as to implement the mode switching method in the embodiments described in the present disclosure. The RAM 1003 further stores various programs and information required for operations of the electronic device 1000. The processing apparatus 1001, the ROM 1002, and the RAM 1003 are interconnected by means of a bus 1004. An input/output (I/O) interface 1005 is also connected to the bus 1004.

Usually, the following apparatus may be connected to the I/O interface 1005: an input apparatus 1006 including, for example, a touch screen, a touch pad, a keyboard, a mouse, a camera, a microphone, an accelerometer, a gyroscope, or the like; an output apparatus 1007 including, for example, a liquid crystal display (LCD), a loudspeaker, a vibrator, or the like; a memory 1008 including, for example, a magnetic tape, a hard disk, or the like; and a communication apparatus 1009. The communication apparatus 1009 may allow the electronic device 1000 to be in wireless or wired communication with other devices to exchange data. While FIG. 6 illustrates the electronic device 1000 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts, so as to implement the mode switching method as described above. In such embodiments, the computer program may be downloaded online through the communication apparatus 1009 and installed, or may be installed from the memory 1008, or may be installed from the ROM 1002. When the computer program is executed by the processing apparatus 1001, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include an information signal that propagates in a baseband or as a part of a carrier and carries computer-readable program codes. The information signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol known or to be researched and developed in the future such as hypertext transfer protocol (HTTP), and may communicate (via a communication network) and interconnect with digital information in any form or medium. Examples of communication networks include a local area network (LAN), a wide area network (WAN), the Internet, and an end-to-end network (e.g., an ad hoc end-to-end network), as well as any network known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a mode selection page in an extended reality space in response to a trigger operation for a mode switching entry, while the extended reality device is running in a first running mode, the mode selection page including a second mode switching option; and switch a running mode of the extended reality device to the second running mode in response to a selection operation for the second mode switching option; in the first running mode, an amount of resources occupied by a base running of a system of the extended reality device is a first amount of resources; in the second running mode, the amount of resources occupied by the base running of the system of the extended reality device is a second amount of resources, the first amount of resources is greater than the second amount of resources; when the running mode of the extended reality device is switched from the first running mode to the second running mode while running a same application, running performance of the application in the extended reality device remains unchanged.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, the present disclosure provides an electronic device including: one or more processor; and a memory configured to store one or more programs, when the one or more programs are executed by the one or more processor, the one or more processor implements the mode switching method according to any one embodiment of the present disclosure.

According to one or more embodiments of the present disclosure, the present disclosure provides a computer-readable storage medium having a computer program stored thereon, and when the program is executed by a processor, the mode switching method according to any embodiment of the present disclosures is implemented.

Embodiments of the present disclosure also provide a computer program product, where the computer program product includes a computer program or instruction, and when the computer program or instruction is executed by a processor, the mode switching method as described above is implemented.

It is to be noted that the relationship terms, such as “first” and “second”, are used herein only for distinguishing one entity or operation from another entity or operation but do not necessarily require or imply that there exists any such actual relationship or sequence between these entities or operations. Also, the terms “comprise”, “include”, or any other variation thereof, are intended to cover a non-exclusive inclusion, such that a process, method, article, or device that includes a list of elements does not include only those elements but also may include other elements not expressly listed or inherent to such process, method, article, or device. Without further limitation, an element defined by the phrase “comprising an . . . ” does not exclude the presence of other identical elements in the process, method, article, or device that includes the element.

The previous description is only for the purpose of describing particular embodiments of the present disclosure, so as to enable those skilled in the art to understand or implement the present disclosure. Many modifications to these embodiments will be obvious to those skilled in the art, and the general principles defined herein may be implemented in other embodiments without departing from the spirit or scope of the present disclosure. Therefore, the present disclosure will not be limited to the embodiments described herein, but is to be accorded the widest scope consistent with the principles and novel features disclosed herein.

1. A mode switching method, comprising:
switching a running mode of an extended reality device to the second running mode in response to an operation for a second mode switching option, during a process that the extended reality device is running in a first running mode; wherein, in the first running mode, an amount of resources occupied by a base running of a system of the extended reality device is a first amount of resources; in the second running mode, the amount of resources occupied by the base running of the system of the extended reality device is a second amount of resources, the first amount of resources is greater than the second amount of resources; when the running mode of the extended reality device is switched from the first running mode to the second running mode while running a same application, running performance of the application in the extended reality device remains unchanged.

2. The mode switching method of claim 1, wherein the switching a running mode of the extended reality device to the second running mode in response to an operation for a second mode switching option, comprises:
displaying a mode selection page in an extended reality space in response to a trigger operation for a mode switching entry, the mode selection page comprising a second mode switching option; and
in response to a selection operation for the second mode switching option, adjusting configuration parameters related to display performance of an environment image in the extended reality space, such that the display performance of the environment image in the extended reality space is higher in the first running mode than in the second running mode.

3. The mode switching method of claim 2, wherein when the extended reality device has a perspective function,
in response to that the extended reality device is running in the first running mode and the perspective function is activated, configuration items related to performance of an environment camera in the extended reality device are configured by using first perspective parameters;
in response to that the extended reality device is running in the second running mode and the perspective function is activated, the configuration items related to the performance of the environment camera in the extended reality device are configured by using second perspective parameters; and
the performance of the environment camera is higher in the first running mode than in the second running mode.

4. The mode switching method of claim 3, wherein,
the configuration parameters related to the display performance of the environment image in the extended reality space comprise at least one selected from a group consisting of a size of an eye buffer and a refresh rate of the environment image displayed in the extended reality space; and
the configuration items related to the performance of the environment camera in the extended reality device comprises at least one selected from a group consisting of a perspective refresh rate and a perspective definition.

5. The mode switching method of claim 1, wherein in response to that the extended reality device runs in the second running mode, the mode switching method further comprises:
in response to that a window of a first application is already displayed in the extended reality space, responding to a selection operation for a second application; and
displaying both of the window of the first application and a window of a second application in the extended reality space.

6. The mode switching method of claim 1, wherein the operation for the second mode switching option comprises displaying a mode selection page in an extended reality space in response to a trigger operation for a mode switching entry, the mode selection page comprising a second mode switching option, and performing a selection operation for the second mode switching option,
wherein the mode selection page further comprises a third mode switching option, and the mode switching method further comprises:
switching the running mode of the extended reality device to the third running mode in response to a selection operation for the third mode switching option;
wherein in third first running mode, an amount of resources occupied by the base running of a system of the extended reality device is a third amount of resources; the second amount of resources is greater than the third amount of resources; when the running mode of the extended reality device is switched from the second running mode to the third running mode while running a same application, running performance of the application in the extended reality device is reduced.

7. The mode switching method of claim 6, further comprising:
in response to that the extended reality device is in the third running mode, placing the second mode switching option in the mode selection page into a restricted selection state.

8. The mode switching method of claim 1, wherein the operation for the second mode switching option comprises displaying a mode selection page in an extended reality space in response to a trigger operation for a mode switching entry, the mode selection page comprising a second mode switching option, and performing a selection operation on the second mode switching option,
the mode selection page further comprises a prompt identifier, and the mode switching method further comprises:
in response to a trigger operation for the prompt identifier, displaying prompt information, wherein the prompt information is configured to prompt a difference between the first running mode and the second running mode.

9. An electronic device, comprising:
one or more processor;
a memory for storing one or more programs;
when the one or more programs are executed by the one or more processor, the one or more processor implements a mode switching method,
wherein the mode switching method comprises:
switching a running mode of an extended reality device to the second running mode in response to an operation for a second mode switching option, during a process that the extended reality device is running in a first running mode,
wherein in the first running mode, an amount of resources occupied by a base running of the extended reality device is a first amount of resources; in the second running mode, the amount of resources occupied by the base running of the extended reality device is a second amount of resources, the first amount of resources is greater than the second amount of resources; when the running mode of the extended reality device is switched from the first running mode to the second running mode while running a same application, a running performance of the application in the extended reality device remains unchanged.

10. The electronic device of claim 9, wherein the switching a running mode of the extended reality device to the second running mode in response to an operation for a second mode switching option, comprises:
displaying a mode selection page in an extended reality space in response to a trigger operation for a mode switching entry, the mode selection page comprising a second mode switching option; and
in response to a selection operation for the second mode switching option, adjusting configuration parameters related to a display performance of an environment image in the extended reality space, such that the display performance of the environment image displayed in the extended reality space is higher in the first running mode than in the second running mode.

11. The electronic device of claim 10, wherein when the extended reality device has a perspective function,
in response to that the extended reality device is running in the first running mode and the perspective function is enabled, configuration items related to a performance of an environment camera in the extended reality device are configured by using first perspective parameters;
in response to that the extended reality device is running in the second running mode and the perspective function is enabled, the configuration items related to the performance of the environment camera in the extended reality device are configured by using second perspective parameters; and
the performance of the environment camera is higher in the first running mode than in the second running mode.

12. The electronic device of claim 11, wherein,
the configuration parameters related to the display performance of the environment image displayed in the extended reality space comprise at least one selected from a group consisting of a size of an eye buffer area and a refresh rate of the environment image displayed in the extended reality space; and
the configuration items related to the performance of the environment camera in the extended reality device comprises at least one selected from a group consisting of a perspective refresh rate and a perspective definition.

13. The electronic device of claim 9, wherein in response to that the extended reality device runs in a second running mode, the mode switching method further comprises:
when a window of a first application is already displayed in the extended reality space, responding to a selection operation for a second application; and
displaying both of the window of the first application and a window of a second application in the extended reality space.

14. The electronic device of claim 9, wherein the operation for the second mode switching option comprises displaying a mode selection page in an extended reality space in response to a trigger operation for a mode switching entry, the mode selection page comprising a second mode switching option, and performing a selection operation for the second mode switching option,
wherein the mode selection page further comprises a third mode switching option, and the method further comprises:
switching the running mode of the extended reality device to the third running mode in response to a selection operation for the third mode switching option,
wherein in the first running mode, an amount of resources occupied by the base running of the system of the extended reality device is a third amount of resources; the second amount of resources is greater than the third amount of resources; when the running mode of the extended reality device is switched from the second running mode to the third running mode while running a same application, a running performance of the application in the extended reality device is reduced.

15. The electronic device of claim 14, further comprising:
in response to that the extended reality device is in the third running mode, placing the second mode switching option in the mode selection page into a restricted selection state.

16. The electronic device of claim 9, wherein the operation for the second mode switching option comprises displaying a mode selection page in an extended reality space in response to a trigger operation for a mode switching entry, the mode selection page comprising a second mode switching option, and performing a selection operation for the second mode switching option,
the mode selection page further comprises a prompt identifier, and the method further comprises:
in response to a trigger operation for the prompt identifier, displaying prompt information, wherein the prompt information is configured to prompt a difference between the first running mode and the second running mode.

17. A non-transitory computer-readable storage medium having computer program stored thereon, characterized in that the program implements a mode switching method when executed by the processor,
wherein the mode switching method comprises:
switching a running mode of an extended reality device to the second running mode in response to a selection for a second mode switching option, during a process that the extended reality device is running in a first running mode; in the first running mode, an amount of resources occupied by a base running of the extended reality device is a first amount of resources; in the second running mode, the amount of resources occupied by the base running of the extended reality device is a second amount of resources, the first amount of resources is greater than the second amount of resources; when the running mode of the extended reality device is switched from the first running mode to the second running mode while running a same application, a running performance of the application in the extended reality device remains unchanged.

18. The computer-readable storage medium of claim 17, wherein the switching a running mode of the extended reality device to the second running mode in response to an operation for a second mode switching option, comprises:
displaying a mode selection page in an extended reality space in response to a trigger operation for a mode switching entry, the mode selection page comprising a second mode switching option; and
in response to a selection operation for the second mode switching option, adjusting configuration parameters related to a display performance of an environment image in the extended reality space, such that the display performance of the environment image displayed in the extended reality space is higher in the first running mode than in the second running mode.

19. The computer-readable storage medium of claim 18, wherein when the extended reality device has a perspective function,
in response to that the extended reality device is running in the first running mode and the perspective function is enabled, configuration items related to a performance of an environment camera in the extended reality device are configured by using first perspective parameters;
in response to that the extended reality device is running in the second running mode and the perspective function is enabled, the configuration items related to the performance of the environment camera in the extended reality device are configured by using second perspective parameters; and
the performance of the environment camera is higher in the first running mode than in the second running mode.

20. The computer-readable storage medium of claim 19, wherein
the configuration parameters related to the display performance of the environment image displayed in the extended reality space comprise at least one selected from a group consisting of a size of an eye buffer area and a refresh rate of the environment image displayed in the extended reality space; and
the configuration items related to the performance of the environment camera in the extended reality device comprises at least one selected from a group consisting of a perspective refresh rate and a perspective definition.
